(19) United States
(12) Patent Application Publication
(10) Pub. No.: US 2013/0304999 A1
(43) Pub. Date: Nov. 14, 2013

(54) ELECTRONIC DEVICE AND SERIAL DATA COMMUNICATION METHOD

(71) Applicant: Masahiro Imai, Osaka-shi (JP)

(72) Inventor: Masahiro Imai, Osaka-shi (JP)

(73) Assignee: SHARP KABUSHIKI KAISHA, Osaka-shi, Osaka (JP)

(21) Appl. No.: 13/825,870

(22) PCT Filed: Sep. 29, 2011
(86) PCT No.: PCT/JP11/72444

§ 371 Date: Mar. 25, 2013

(30) Foreign Application Priority Data
Oct. 6, 2010 (JP) 2010-226616

(51) Int. Cl. G06F 12/00

(52) U.S. Cl. CPC G06F 12/00
USPC 711/154

(57) ABSTRACT

In a case where specific data (enable write data) is written in an enable/disenable register (11) of a register group (10) included in a slave device (3) via serial data communication, it is possible to write data in at least part of the register group (10) other than the enable/disenable register (11) of the register group (10), in response to an enabling signal supplied from a function block (12).

### TECHNICAL FIELD

The present invention relates to (i) a serial data communication method and (ii) an electronic device for establishing serial data communication.

### BACKGROUND ART

There have developed many data transmission methods (compliant with interface specifications) of transmitting data between a plurality of electronic circuits (between a master device and a slave device(s)).

Among the data transmission methods, for example, I2C communication can establish serial data communication at a relative high speed via a data signal line and a clock signal line. Further, a plurality of slave devices, for example, a plurality of ICs can be connected to a master device. Therefore, the I2C communication is generally employed for relatively short-distance transmission of data between a plurality of electronic circuits which are provided on a substrate.

FIG. 6 is a view showing examples of a data signal and a clock signal which are transmitted from a master device via a data signal line and a clock signals line to a plurality of slave devices.

(a) of FIG. 6 is a view showing a case where no noise overlaps with the data signal line and the clock signal line. As shown in (a) of FIG. 6, H, L, H, L, H, and L are sampled as data at respective timings t1, t2, t3, t4, t5, and t6.

In the I2C communication, the plurality of slave devices share a data signal and a clock signal. Therefore, an output section for outputting the data signal and the clock signal is realized by an open collector device or an open drain device, and is configured to carry out high-level output by use of a pull-up resistor.

Hence, the data signal line and the clock signal line each have relatively high output impedance, and are easily subjected to noise.

(b) of FIG. 6 is a view showing a case where noise overlaps with the clock signal line. As shown in (b) of FIG. 6, such overlapping causes a voltage level to unintentionally fall between a timing t2 and a timing t2′.

Such unintentional fall of the voltage level causes H, L, L, H, L, H, and L to be sampled as data at respective timings t1, t2, t2′, t3, t4, t5, and t6.

Properly, the H, L, H, L, H, and L should be sampled as data, as shown in (a) of FIG. 6. However, the noise causes erroneous sampling of the H, L, L, H, L, H, and L in which bit error occurs.

(c) of FIG. 6 is a view showing a case where noise overlaps with the data signal line. As shown in (c) of FIG. 6, such overlapping causes a voltage level to unintentionally fall in the data signal line at a timing close to a timing t3.

Properly, H should be sampled as data at the timing t3, as shown in (a) of FIG. 6. However, the noise causes erroneous sampling of L.

Thus, in a case where (i) erroneous data is sampled due to noise and (ii) the erroneous data is written in a register included in a slave device such as an IC, the IC malfunctions.

The following efforts have been conventionally made so as to prevent the malfunction caused by writing of the erroneous data to the register included in the slave device.

For example, Patent Literature 1 describes how to prevent erroneous data from being written in a register included in a slave device due to external noise n1 or external noise n2 (later described in detail) which are illustrated in FIG. 7.

FIG. 7 is an explanatory view for describing types of external noise which occurs in I2C communication.

The I2C communication can transfer data at any timing. It is therefore general that the I2C communication has a time period during which data transfer is suspended, and a data transfer period, as shown in FIG. 7.

The external noise n1 is noise which will overlap with a data signal line SDA and a clock signal line SCL during the time period during which data transfer is suspended. The external noise n2 is noise which will overlap with the data signal line SDA and the clock signal line SCL during the data transfer period.

FIG. 8 is a view schematically showing a configuration of a conventional device 300 (described in Patent Literature 1) capable of preventing erroneous data from being written in a register group 202 included in a slave device 200 due to external noise n1.

As illustrated in FIG. 8, according to the configuration of the conventional device 300, a master device 100 includes an I2C slave device controlling section 104 so that it is possible to prevent malfunction caused by the external noise n1 during the time period during which data transfer is suspended (see FIG. 7).

A start condition issuing section 105 of a CPU 101 included in the master device 100 issues a start condition, so that the master device 100 supplies data to the slave device 200 (which controls the register group 202 to store data written by the master device 100, and whose function block 203 carries out its function on the basis of the data). Specifically, a data signal is switched from High to Low while a clock signal is being High.

The start condition (signal) issued by the start condition issuing section 105 of the CPU 101 is supplied not only to an I2C section 102 but also to the I2C slave device controlling section 104 (see FIG. 8).

The signal supplied by the start condition issuing section 105 is detected by a start condition detecting section 107 of the I2C slave device controlling section 104. The I2C slave device controlling section 104, whose start condition detecting section 107 has detected the signal, supplies an I2C enabling signal to an I2C section 201 via a transmission path 302, which I2C enabling signal enables the I2C section 201.

Note that the I2C section 102 included in the master device 100 is electrically connected to the I2C section 201 included in the slave device 200 via an I2C bus transmission path 301 made up of a data signal line SDA and a clock signal line SCL.

A stop condition issuing section 106 of the CPU 101 issues a stop condition, so that the master device 100 suspends supplying of data to the slave device 200. Specifically, a data signal is switched from Low to High while a clock signal is being High.

The stop condition (signal) issued by the stop condition issuing section 106 of the CPU 101 is supplied not only to the I2C section 102 but also to the I2C slave device controlling section 104 (see FIG. 8).

The signal supplied by the stop condition issuing section 106 is detected by a stop condition detecting section 108 of the I2C slave device controlling section 104. The I2C slave device controlling section 104, whose stop condition detecting section 108 has detected the signal, supplies an I2C enabling signal to the I2C section 201 via the transmission path 302, which I2C enabling signal disenables the I2C section 201.

Thus, the I2C slave device controlling section 104 is configured to supply, in accordance with a signal supplied from the CPU 101, the I2C enabling signal which enables the I2C section 201 or disenables the I2C section 201.

The I2C section 201, which is made disenable, does not operate regardless of states of the data signal line SDA and the clock signal line SCL. Therefore, erroneous data is not written to the register group 202 while the I2C section 201 is made disable.

According to the configuration, the I2C section 201 is made disenable by the I2C enabling signal which disenables the I2C section 201 during the time period during which data transfer is suspended, and, in contrast, the I2C section 201 is made enable by the I2C enabling signal which enables the I2C section 201 during the data transfer period. It is therefore possible to prevent erroneous data from being written to the register group 202 included in the slave device 200 due to the external noise n1 that is noise which overlaps with the data signal line SDA and the clock signal line SCL during the time period during which data transfer is suspended. This makes it possible to prevent the conventional device 300 from malfunctioning.

FIG. 9 is a view schematically showing a configuration of a conventional device 300a (described in Patent Literature 1) capable of preventing erroneous data from being written in a register group 202 included in a slave device 200 due to external noise n2.

A master device 100 of the conventional device 300a shown in FIG. 9 includes an interrupt controlling section (error detection notifying means) 109 instead of the I2C slave device controlling section 104 included in the master device 100 of the conventional device 300 shown in FIG. 8.

The slave device 200 of the conventional device 300a is configured to further include an error detecting section (error detection notifying means) 220 and an interrupt controlling section (error detection notifying means) 221. The configuration is different from that shown in FIG. 8.

The error detecting section 220 is configured to detect an error which occurs in the slave device 200 during data transfer. The error detecting section 220 receives a signal supplied from an I2C section 201, and detects an error of data on the basis of the signal during data transfer of the data. The error detecting section 220, which has detected the error, supplies control signals (an I2C section reset signal, a register writing prohibition signal, and an error interrupt signal) to the I2C section 201 and the interrupt controlling section 221.

The interrupt controlling section 109 is provided in the master device 100, and the interrupt controlling section 221 is provided in the slave device 200. The interrupt controlling section 109 is connected to the interrupt controlling section 221 via a signal line which is neither a data signal line SDA nor a clock signal line SCL. The interrupt controlling sections 109 and 221 are sections for notifying the master device 100 of an error which occurs during data transfer.

The error detecting section 220, which has detected an error occurring during data transfer, supplies, to the interrupt controlling section 221, an error interrupt signal which serves as a control signal. The error interrupt signal is supplied to the interrupt controlling section 109 via the interrupt controlling section 221. This allows the master device 100 to recognize that the error has occurred during the data transfer.

In a case where the error detecting section 220 detects no error, the slave device 200 (i) recognizes, as correct data, data which has been supplied from the master device 100 and temporality stored in an I2C reception section of the I2C section 201, and (ii) causes a register writing section to write the data at appropriate address of the register group 202.

In contrast, in a case where the error detecting section 220 detects an error, the slave device 200 (i) recognizes, as erroneous data, data supplied from the master device 100, and (ii) causes the error detecting section 220 to supply, as control signals, a register writing prohibition signal, an I2C section reset signal, and an error interrupt signal to the I2C reception section of the I2C section 201, the I2C section 201, and the interrupt controlling section 221, respectively.

The I2C reception section of the I2C section 201, which has received the register writing prohibition signal, abandons the data which has been supplied from the master device 100 and temporarily stored in the I2C reception section so that the data is not to be written to the register group 202.

According to the configuration, it is thus possible to prevent erroneous data from being written in the register group 202 included in the slave device 200 due to the external noise n2. This makes it possible to prevent the conventional device 300a from malfunctioning.

### CITATION LIST

### Patent Literature

Patent Literature 1
Japanese Patent Application Publication, Tokukai No. 2008-197752 A (Publication Date: Aug. 28, 2008)

### SUMMARY OF INVENTION

### Technical Problem

However, in a case where an electronic device is configured to include (i) a single master device having a configuration of the master device 100 (see Patent Literature 1) illustrated in FIG. 8 and (ii) a plurality of slave devices (slave devices 1, 2, . . . , and N) each having a configuration of the slave device 200 (see Patent Literature 1) illustrated in FIG. 8, the single master device issues a start condition and a stop condition to the plurality of slave devices (slave devices 1, 2, . . . , and N) as a common command.

Therefore, according to the configuration, in response to a signal (a start condition or a stop condition) supplied from a CPU 101 of the master device, an I2C slave device controlling section 104 supplies, to I2C sections 201 of the plurality of respective slave devices (slave devices 1, 2, . . . , and N), an enabling signal which concurrently enables the I2C sections 201 or a disenabling signal which concurrently disenables the I2C sections 201.

This causes all of the plurality of slave devices (slave devices 1, 2, . . . , and N) to be concurrently enabled, thereby causing the following problems.

FIG. 11 is a view illustrating a conventional write sequence.

It was conventionally general to use the write sequence (illustrated in FIG. 11) containing slave address, address data, and write data.

In a case where data is written, by use of the conventional write sequence illustrated in FIG. 11, at specific address of a register group included in a specific slave device of the plurality of slave devices (slave devices 1, 2, . . . , and N) which are configured to be concurrently enabled, the data is possibly written in a slave device other than the specific slave device of the plurality of slave devices by sampling of erroneous data (see (b) and (c) of FIG. 6) as data of slave address of the specific slave device due to noise generated during serial data communication.

As early described, the plurality of slave devices (slave devices 1, 2, . . . , and N) are configured to be all enabled concurrently. Therefore, there is risk that communication with an unintended slave device causes the electronic device to malfunction. This is one of the problems.

The configuration illustrated in FIG. 8 and described in Patent Literature 1 should include not only the I2C bus transmission path 301 made up of the data signal line SDA and the clock signal line SCL but also the transmission path 302 through which an I2C enabling signal is supplied. This increases the number of signal lines which connect the master device and the slave device.

The error detecting section 220, included in the slave device 200 having the configuration illustrated in FIG. 9 and described in Patent Literature 1, includes a data signal state shift determining section and a clock signal counting confirming section.

In a case where, for example, the master device consecutively supplies, to the slave device, n pieces of 8-bit write data after supplying 7-bit slave address and 8-bit address data, the error detecting section 220 can be notified of whether or not an error occurs in the I2C bus transmission path 301 during supply of the data, by confirmation of whether or not the number of counted clock signals is (2+n)×9−1 when the slave device receives a stop condition detection signal. The confirmation is carried out by the clock signal counting confirming section.

That is, according to the configuration, write data cannot be reflected without input of a stop condition. This makes it impossible to reflect n pieces of write data directly after writing of the n pieces of write data while consecutively writing the n pieces of write data.

In a case where (i) a data signal does not shift from High to Low (or conversely, does not shift from Low to High) while a clock signal like the clock signal illustrated in (c) of FIG. 6 is being High, and (ii) a pulse number of the clock signal like the clock signal illustrated in (c) of FIG. 6 does not change, noise occurs, and erroneous data is sampled. Nonetheless, the error detecting section 220 cannot detect the erroneous data during transfer of the erroneous data.

Further, the configuration illustrated in FIG. 9 and described in Patent Literature 1 should also include not only the I2C bus transmission path 301 made up of the data signal line SDA and the clock signal line SCL but also another signal line through which an error interrupt signal is supplied. This increases the number of signal lines which connect the master device and the slave device.

The present invention was made in view of the problems, and an object of the present invention is to provide (i) an electronic device and (ii) a serial data communication method, each of which being capable of preventing malfunction caused by writing of erroneous data without including any additional signal line.

### Solution to Problem

In order to attain the object, an electronic device of the present invention is configured to include a first device; and a second device including a storage section and a control section, the first device and the second device establishing serial data communication with each other via a data signal line and a clock signal line, the control section enabling data to be written in at least part of the storage section other than a first part of the storage section, in a case where first specific data is written in the first part via the serial data communication.

According to the configuration, in the second device, the control section disenables data to be written in the at least part of the storage section other than the first part of the storage section unless the first specific data is written in the first part of the storage section.

With this configuration, even in a case where erroneous data is sampled due to noise in the serial data communication, the control section disenables data to be written in the at least part of the storage section other than the first part of the storage section unless the first specific data is written in the first part of the storage section.

It is therefore possible to reduce a possibility that erroneous data is written in the at least part of the storage section other than the first part of the storage section in a case where the erroneous data is sampled due to noise in the serial data communication.

Further, according to the configuration, the control section enables data to be written in the at least part of the storage section other than the first part of the storage section, in a case where the first specific data is written in the first part of the storage section of the second device via the serial data communication. It is therefore unnecessary to provide a signal line other than the data signal line and the clock signal line. This causes no increase in the number of signal lines.

Hence, it is possible to realize an electronic device, with no increase in the number of signal lines, which is capable of preventing malfunction caused by writing of erroneous data.

In order to attain the object, a serial data communication method of the present invention is arranged to be a serial data communication method carried out by use of a data signal line and a clock signal line, wherein: enabling data, which enables data to be written in at least part of a storage section other than a first part of the storage section included in a target device with which the serial data communication is established via the data signal line and the clock signal line, contains: first data which specifies the target device; second data which specifies the first part in the storage section included in a specified target device, and third data to be written in the first part of the storage section.

According to the method, the enabling data, which enables data to be written in the at least part of the storage section other than the first part of the storage section included in the target device with which the serial data communication is established via the data signal line and the clock signal line, contains: the first data which specifies the target device; the second data which specifies the first part in the storage section included in the specified target device, and the third data to be written in the first part of the storage section.

Therefore, in a case where erroneous data is sampled due to noise in the serial data communication, the third data cannot be written in a first part of a storage section included in a predetermined target device which is specified by the first data as a device with which the serial data communication is established, the first part being specified by the second data. It is therefore impossible to write data in at least part of the storage section other than the first part of the storage section included in the predetermined target device.

This makes it possible to reduce a possibility that erroneous data is written to the at least part of the storage section other than the first part of the storage section in a case where the erroneous data is sampled due to noise in the serial data communication.

Further, according to the method, it is unnecessary to provide a signal line other than the data signal line and the clock signal line. This causes no increase in the number of signal lines.

Hence, it is possible to realize a serial data communication method, with no increase in the number of signal lines, which is capable of preventing malfunction caused by writing of erroneous data.

### Advantageous Effects of Invention

Thus, an electronic device of the present invention is configured so that (i) the second device includes a storage section and a control section and (ii) the control section enables data to be written in at least part of the storage section other than a first part of the storage section, in a case where first specific data is written in the first part via the serial data communication.

Thus, in a serial data communication method of the present invention, enabling data, which enables data to be written in at least part of a storage section other than a first part of the storage section included in a target device with which the serial data communication is established via the data signal line and the clock signal line, contains: first data which specifies the target device; second data which specifies the first part in the storage section included in a specified target device, and third data to be written in the first part of the storage section.

Hence, it is possible to realize an electronic device and a serial data communication method each capable of preventing malfunction caused by writing of erroneous data with no increase in the number of signal lines.

### BRIEF DESCRIPTION OF DRAWINGS

FIG. 1 is a block diagram schematically illustrating a configuration of an electronic device in accordance with an embodiment of the present invention.

FIG. 2 is a view illustrating a case where the electronic device illustrated in FIG. 1 cannot write data to a register other than an enable/disenable register of a register group.

FIG. 3 is a view schematically illustrating a configuration of an electronic device in accordance with an embodiment of the present invention, which electronic device includes a mater device and N slave devices.

FIG. 4 is a view illustrating a write sequence employed by an electronic device in accordance with an embodiment of the present invention.

FIG. 5 is a view illustrating a transmission protocol example employed by an electronic device in accordance with an embodiment of the present invention.

FIG. 6 is a view exemplifying a data signal and a clock signal which are supplied to a plurality of slave devices via a data signal line and a clock signal line from a master device.

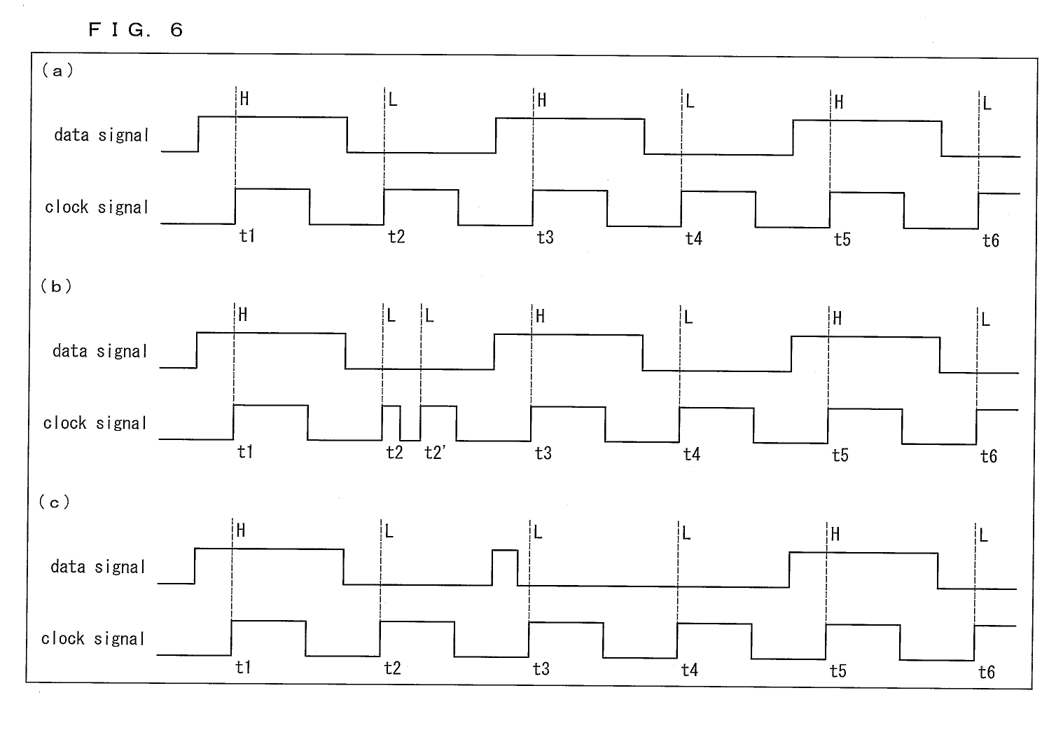

FIG. 7 is an explanatory view for describing types of external noise which will occur in I2C communication.

FIG. 8 is a view schematically illustrating a configuration of a conventional device, described in Patent Literature 1, which is capable of preventing erroneous data from being written in a register group included in a slave device due to external noise n1.

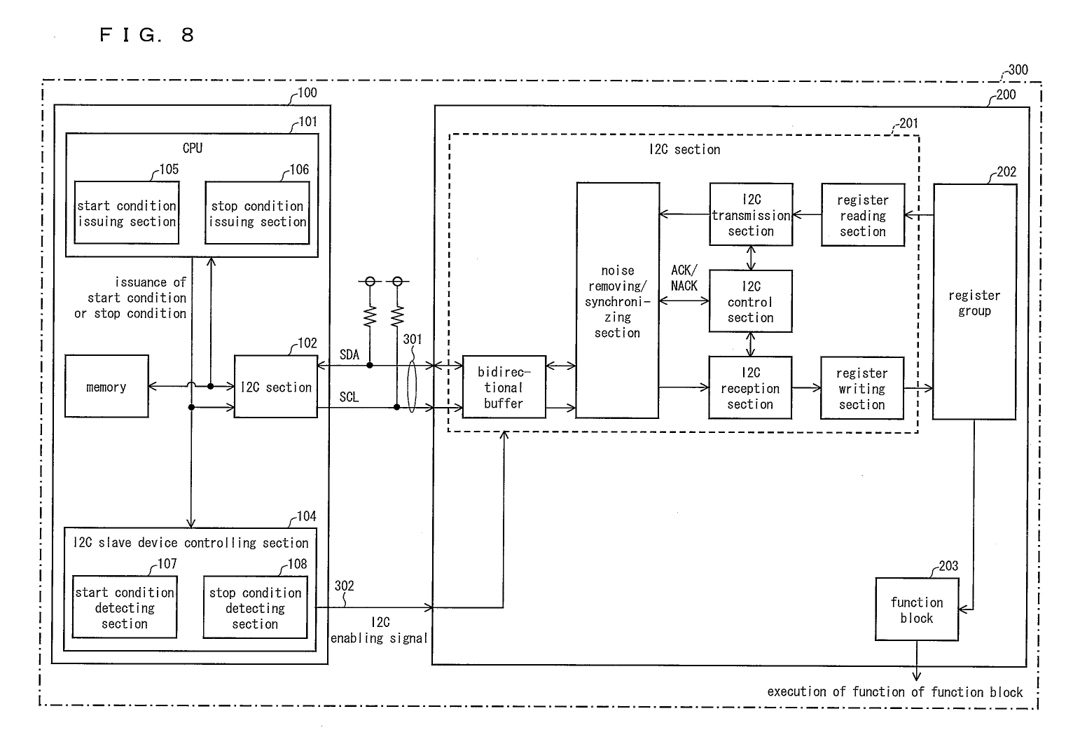

FIG. 9 is a view schematically illustrating a configuration of a conventional device, described in Patent Literature 1, which is capable of preventing erroneous data from being written in a register group included in a slave device due to external noise n2.

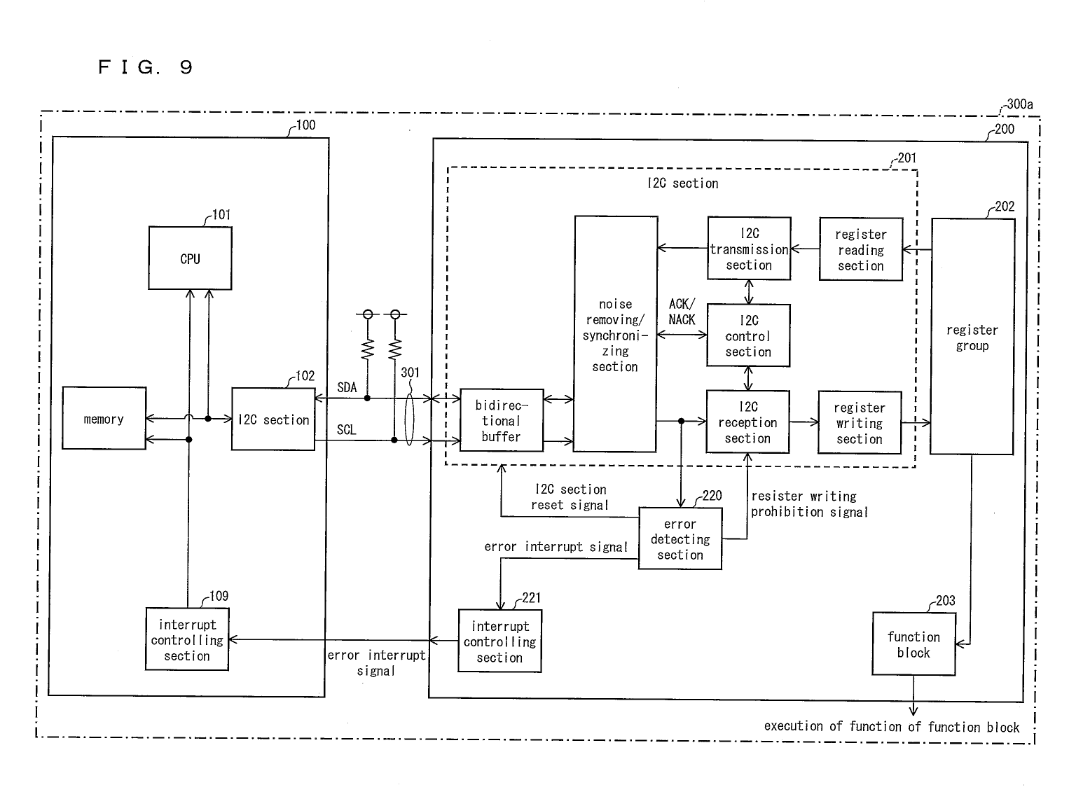

FIG. 10 is a view illustrating a configuration of a conventional electronic device including a single master device and N slave devices.

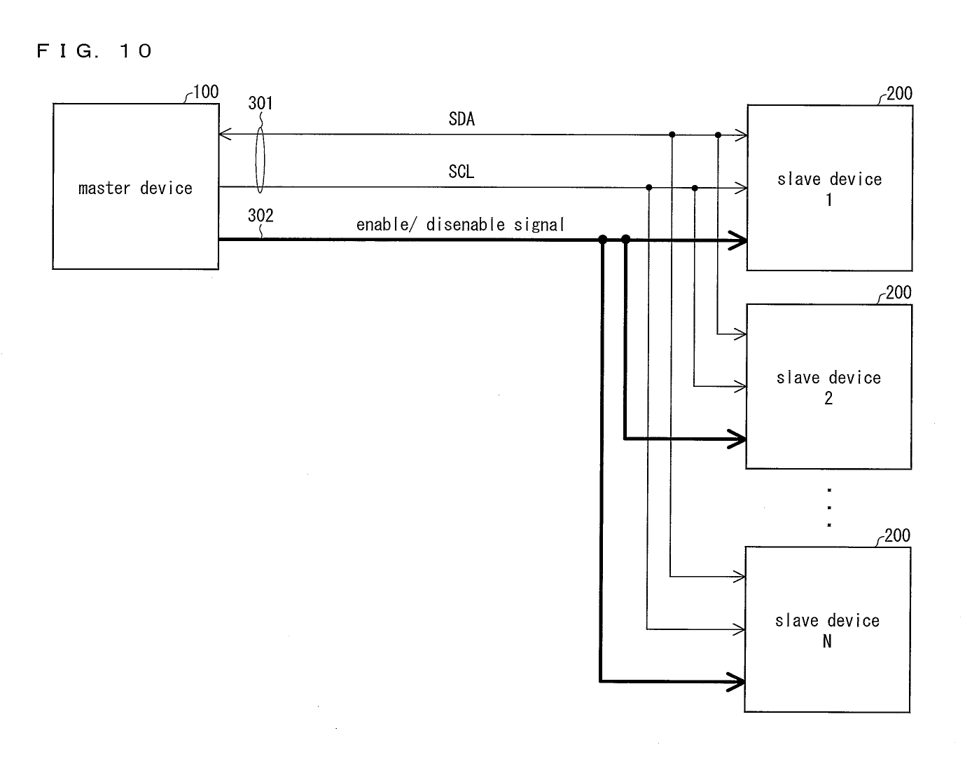

FIG. 11 is a view illustrating a conventional write sequence.

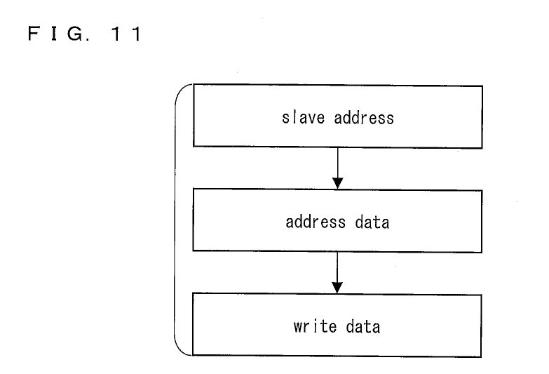

### DESCRIPTION OF EMBODIMENTS

The following description will specifically discuss an embodiment of the present invention with reference to the drawings. Note, however, that the dimensions, materials, shapes, relative locations, and the like of components described in the embodiment are illustrative only, and should not therefore cause the scope of the present invention to be narrowly construed.

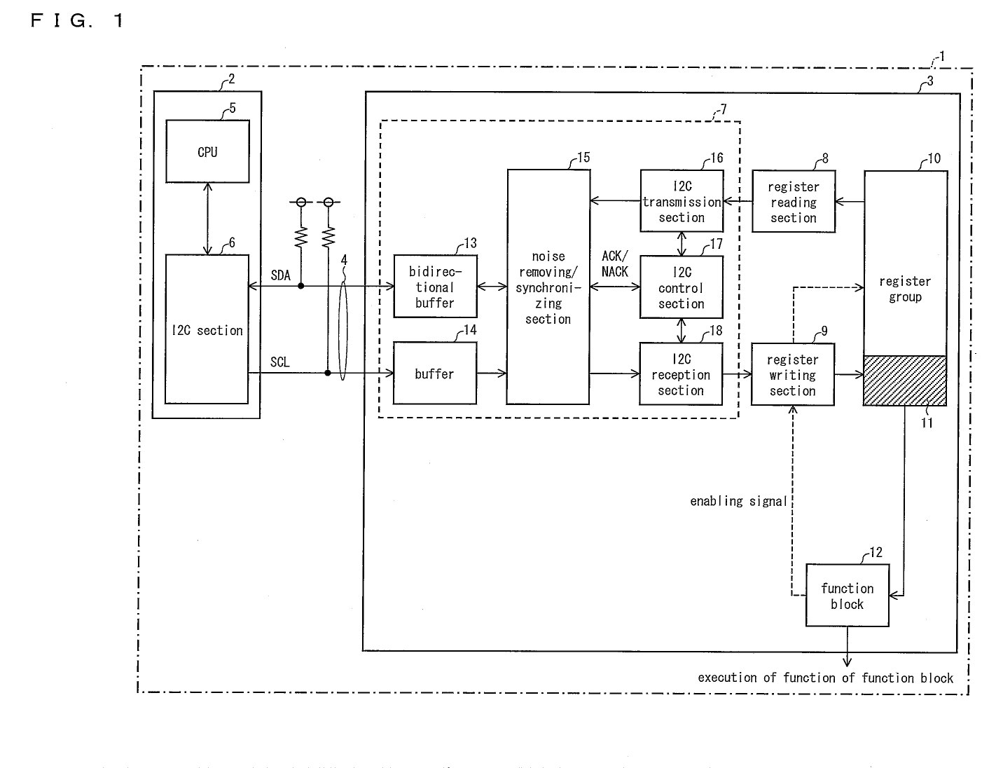

FIG. 1 is a block diagram schematically illustrating a configuration of an electronic device 1 which includes an I2C bus transmission path 4 compliant with an interface specification of I2C communication.

As illustrated in FIG. 1, in the electronic device 1, a master device 2 (first device) and a slave device 3 (second device) are connected to each other by the I2C bus transmission path 4 containing a clock signal line SCL and a data signal line SDA.

The clock signal line SCL is a line via which a clock signal is transmitted. The data signal line SDA is a line via which data, such as address data and write data, are transmitted.

The master device 2 is a device for (i) writing predetermined data to the slave device 3 and (ii) reading out data from the slave device 3.

As illustrated in FIG. 1, the master device 2 includes (i) a CPU (Central Processing Unit) 5, (ii) an I2C section 6 for operating so as to comply with an interface specification of I2C communication, and (iii) a memory (not illustrated).

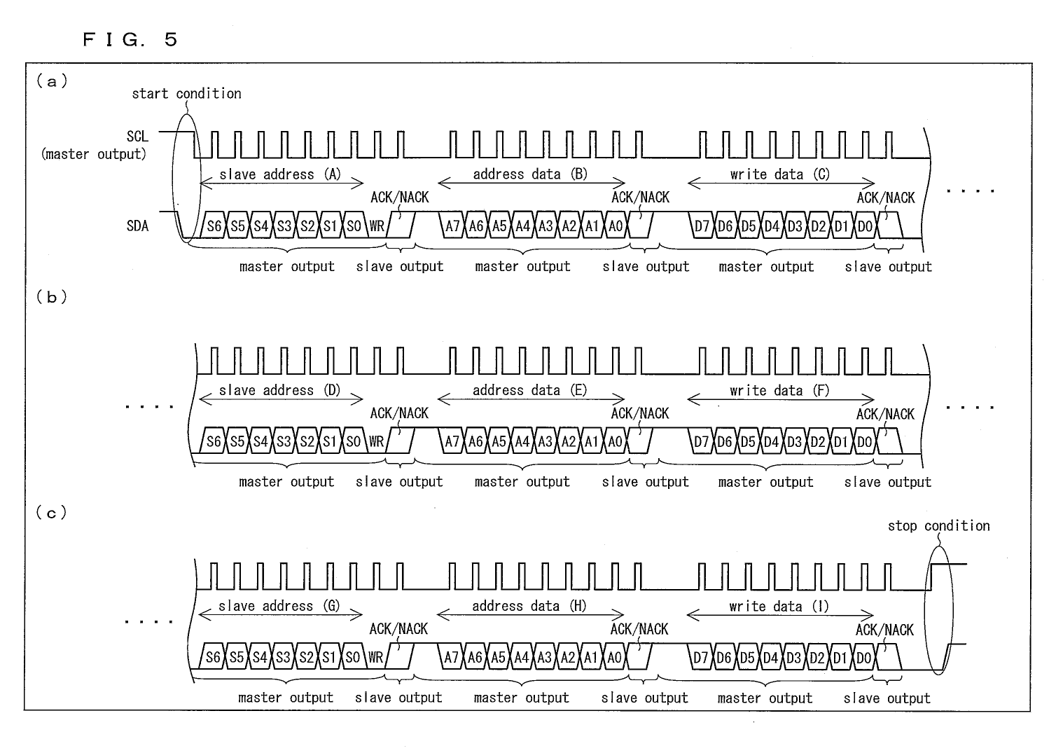

The CPU 5 (i) controls writing operation and read-out operation between the master device 2 and the slave device 3 and (ii) supplies, to the I2C section 6, conditions such as a start condition and a stop condition (later described) which are illustrated in FIG. 5.

The I2C section 6 is connected to the clock signal line SCL and the data signal line SDA so as to operate and comply with the interface specification of I2C communication.

The memory can store data such as a program which is executed by the CPU 5.

The slave device 3 includes an I2C section 7, a register readout section 8, a register writing section 9, a register group 10 (storage section), and a function block 12 (control section). The I2C section 7 operates so as to comply with an interface specification of I2C communication for communicating with the master device 2.

The slave device 3 controls the register group 10 to store data written by the master device 2. The function block 12 carries out its function on the basis of the data.

The I2C section 7 includes a bidirectional buffer 13, a buffer 14, a noise removing and synchronizing section 15, an I2C transmission section 16, an I2C control section 17, and an I2C reception section 18.

The bidirectional buffer 13 is connected to the I2C section 6, via the data signal line SDA. The bidirectional buffer 13 is configured to have high impedance upon reception of a data signal from the master device 2. This causes the bidirectional buffer 13 to supply the data signal to an internal circuit.

In a case where a data signal is supplied to the master device 2, the bidirectional buffer 13 is configured to have a logical level of Low output or high impedance. This causes the bidirectional buffer 13 to supply the data signal to the master device 2.

That is, the bidirectional buffer 13 is configured to switch between (i) the operation of supplying a data signal to the internal circuit and (ii) the operation of supplying a data signal to the master device 2, depending on whether the bidirectional buffer 13 has received the data signal from the master device 2 or outputted the data signal to the master device 2, respectively.

The buffer 14 is connected to the I2C section 6, via the clock signal line SCL. The buffer 14 is configured to supply, to the internal circuit, a clock signal supplied from the master device 2.

In the present embodiment, the data signal line SDA is connected to the bidirectional buffer 13, and the clock signal line SCL is connected to the buffer 14. The present embodiment is, however, not limited to the configuration. A bidirectional buffer can be employed as the buffer 14, for example, in a case where (i) the slave device 3 serves as a master device and (ii) the master device 2 serves as a slave device, and (iii) the slave device supplies a clock signal to the master device.

The noise removing and synchronizing section 15 carries out, in accordance with details of control carried out by the I2C control section 17, an operation of outputting or inputting data via the data signal line SDA.

In a case where the master device 2 reads out the data from the slave device 3, the I2C transmission section 16 (i) receives, via the register reading section 8, data stored in the register group 10 and then (ii) supplies the data to the master device 2 via the noise removing and synchronizing section 15, the bidirectional buffer 13, and the data signal line SDA.

The I2C control section 17 controls the bidirectional buffer 13 to switch, at a predetermined timing, between inputting and outputting of data. As the result of such switching, the I2C transmission section 16 controls (i) a timing at which the I2C transmission section 16 (above described) supplies data to the master device 2 and (ii) a timing at which the I2C reception section 18 (later described) supplies data to the register writing section 9.

The I2C reception section 18 determines whether or not slave address contained in data supplied from the master device 2 is identical to slave address of the slave device 3. The I2C reception section 18 supplies, to the I2C control section 17, an instruction to (i) cause the bidirectional buffer 13 to have high impedance and (ii) notify the master device 2 of “NACK”, (i) in a case where the I2C reception section 18 determines that the slave address contained in the data supplied from the master device 2 is not identical to the slave address of the slave device 3 or (ii) in a case where the slave device 3 is so busy that the slave device 3 cannot receive data.

Further, the I2C reception section 18 is configured to write data to a register of the register group 10 via the register writing section 9, so that the slave device 3 can store the data supplied from the master device 2.

As illustrated in FIG. 1, the register group 10 is made up of a plurality of registers. Data supplied from the master device 2 is written in the register group 10. The function block 12 carries out its function, by reading out the data via a reading section (not illustrated) provided between the register group 10 and the function block 12.

As illustrated in FIG. 1, an enable/disenable register 11 is contained in the plurality of registers of the register group 10 included in the slave device 3 of the electronic device 1.

In a case where data supplied from the master device 2 is written in a register(s) other than the enable/disenable register 11 of the register group 10, the function block 12 carries out its function, by reading out the data via the reading section. Meanwhile, in a case where specific data supplied from the master device 2 is written in the enable/disenable register 11, the function block 12 supplies an enabling signal to the register writing section 9, by reading out the specific data via the reading section.

In a case where data other than the specific data supplied from the master device 2 is written in the enable/disenable register 11, the function block 12 supplies a disenabling signal to the register writing section 9, by reading out the data via the reading section.

Initial condition of the register writing section 9 is set so that data can be merely written in the enable/disenable register 11, and therefore data cannot be written in any register other than the enable/disenable register 11 of the register group 10.

In order to allow the register writing section 9 to write data in a register other than the enable/disenable register 11 of the register group 10, it is necessary that the function block 12 supplies an enabling signal to the register writing section 9, by (i) writing of predetermined data (enable write data) in the enable/disenable register 11 and then (ii) reading out the predetermined data via the reading section.

Upon receipt of the enabling signal from the function block 12, the register writing section 9 is allowed to write data in the register other than the enable/disenable register 11 of the register group 10.

Note that, if necessary, the register group 10 can contain a register in which data can be freely written regardless of writing of the predetermined data in the enable/disenable register 11.

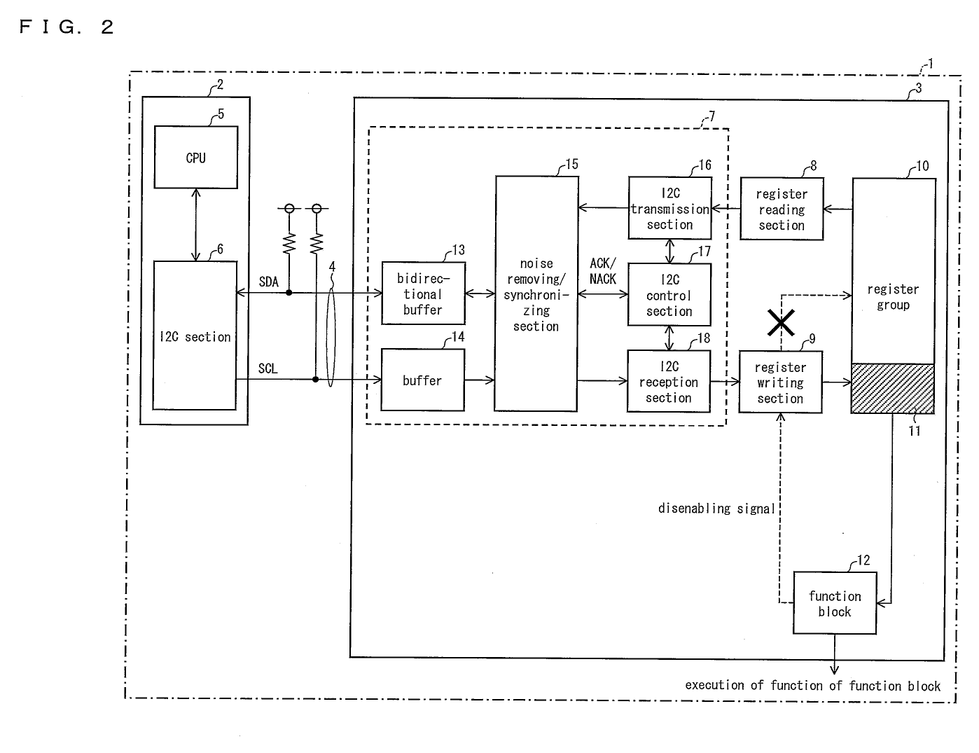

FIG. 2 is a view illustrating a case where the electronic device 1 illustrated in FIG. 1 cannot write data in the register other than the enable/disenable register 11 of the register group 10.

In order not to allow the register writing section 9 to write data in a register other than the enable/disenable register 11 of the register group 10 (see FIG. 2), it is necessary that the function block 12 supplies a disenabling signal to the register writing section 9 by (i) writing of predetermined data (disenable write data) in the enable/disenable register 11, and then (ii) reading out the predetermined data via the reading section.

Upon receipt of the disenabling signal from the function block 12, the register writing section 9 disenables data to be written in the register other than the enable/disenable register 11 of the register group 10.

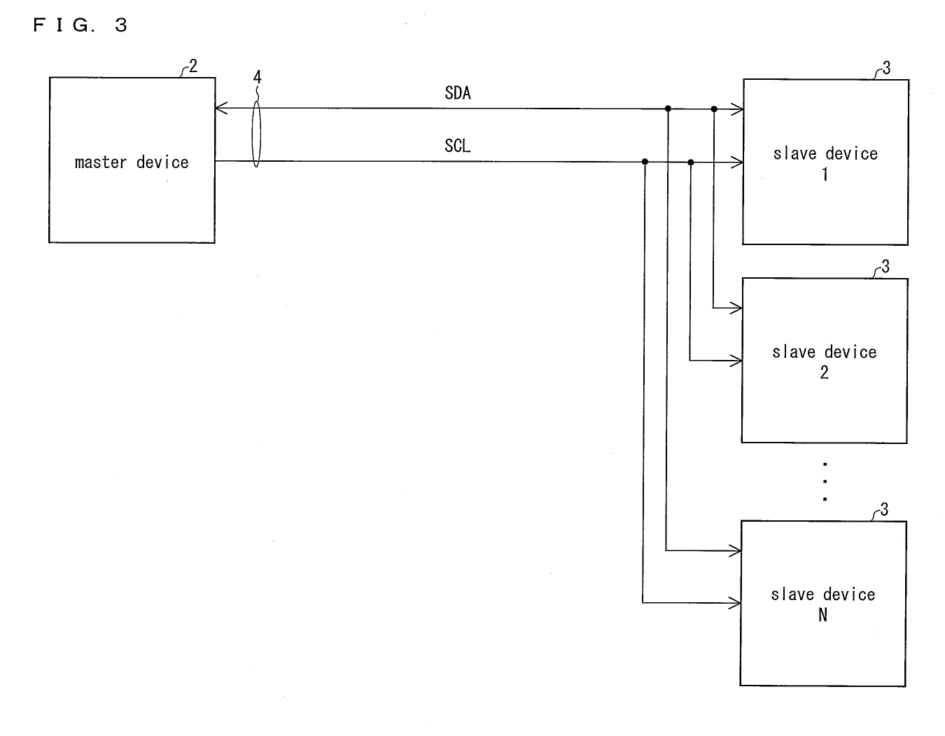

FIG. 3 is a view schematically illustrating a configuration of an electronic device 1 which includes a single mater device 2 and N slave devices 3.

Note that FIGS. 1 and 2 each do not illustrate all of the N slave devices 3 but illustrate merely one of the N slave devices 3. In reality, as illustrated in FIG. 3, the master device 2 is connected to each of the N slave devices 3 via the I2C bus transmission path 4 made up of the clock signal line SCL and the data signal line SDA.

In the present embodiment, the single master device 2 is connected to the N slave devices 3 via the I2C bus transmission path 4 (see FIG. 3). This allows the single master device 2 to carry out various functions. The present embodiment is, however, not limited to this. Alternatively, the electronic device 1 can be configured to include a single slave device 3.

According to the configuration illustrated in FIG. 3, the N slave devices 3 share the clock signal line SCL and the data signal line SDA. It follows that the master device 2 has merely two output terminals for respective of the clock signal line SCL and the data signal line SDA. It is therefore possible to decrease the number of output terminals of the mater device 2.

Note that, in the present embodiment, the N slave devices 3 share the single clock signal line SCL and the single data signal line SDA so that the number of output terminals of the master device 2 is decreased. However, the present embodiment is not limited to this. For example, the master device 3 can be connected to each of the N slave devices via a corresponding clock signal line SCL and a corresponding data signal line SDA.

Furthermore, it is preferable that each predetermined data (enable write data), to be written in the enable/disenable register 11 so that the register writing section 9 can write data in the register other than the enable/disenable register 11 of the register group 10, is prepared for a corresponding one of the N slave devices 3 illustrated in FIG. 3.

That is, according to the present embodiment, each unique predetermined data (enable write data) is written in an enable/disenable register 11 of a corresponding one of the N slave devices 3. The present embodiment is, however, not limited to this.

The electronic device 1 is configured so that each unique and specific data (enable write data) is written in the enable/disenable register 11 of the register group 10 included in a corresponding slave device 3, via serial data communication. Upon receipt of an enabling signal from the function block 12, the register writing section 9 can write data in a register other than the enable/disenable register 11 of the register group 10.

According to the configuration, the register writing section 9 cannot write data in the register other than the enable/disenable register 11 of the register group 10 unless the each unique and specific data (enable write data) is written in the enable/disenable register 11 of the register group 10.

With the configuration, even in a case where an erroneous value is sampled, due to noise, as slave address (second device specifying signal) which specifies one of the N slave devices 3 (later described in detail), the register writing section 9 cannot write data in a register other than the enable/disenable register 11 of the register group 10, unless each specific data (enable write data) for a corresponding slave device 3, which has been erroneously specified, is written in the enable/disenable register 11 of the register group 10 of the slave device 3.

Thus, there is an extremely low possibility that each unique and specific data (enable write data) for a corresponding slave device 3 is written in the enable/disenable register 11 of the register group 10 in the slave device 3 which has been erroneously specified. With the configuration, it is therefore possible to realize an electronic device 1 capable of preventing malfunction, as much as possible, caused by writing of an erroneous value.

With the configuration, it is unnecessary to provide a signal line other than the data signal line(s) SDA and the clock signal line(s) SCL. This causes no increase in the number of signal lines.

Further, according to the configuration, the register writing section 9 writes data in the register other than the enable/disenable register 11 of the register group 10 included in the slave device 3. Then, data (disenable write data) other than the each unique and specific data (enable write data) is written in the enable/disenable register 11 of the register group 10, via serial data communication. Upon reception of a disenabling signal from the function block 12, the register writing section 9 cannot write data in a register other than the enable/disenable resister 11 of the register group 10.

Therefore, the register writing section 9 disenables data to be written in the register other than the enable/disenable resister 11 of the register group 10 for a first time period other than a second time period during which data is written in the register other than the enable/disenable resister 11 of the register group 10. Examples of the first time period encompass (i) a time period during which data transfer is suspended in the serial data communication and (ii) a time period of the serial data communication established between the master device 2 and a specific slave device 3, during which time period a slave device 3 other than the specific slave device 3 does not establish the serial data communication with the master device 2.

It is therefore possible to realize an electronic device 1 capable of preventing possible erroneous writing during the first time period other than the second time period during which data is written in the register other than the enabling/disenabling resister 11 of the register group 10 included in the slave device 3.

In a case of the configuration illustrated in FIG. 3, an output section for outputting a data signal and a clock signal is realized by, for example, an open collector device or an open drain device whose output impedance is relatively high. This causes the output section to be susceptible to noise. In view of the circumstances, it is possible to suitably employ the configuration which is employed in the present embodiment and which can prevent malfunction caused by writing of an erroneous value.

As illustrated in FIGS. 1 and 2, the function block 12 included in the slave device 3 carries out a function of supplying an enabling signal or a disenabling signal to the register writing section 9. The function block 12 further carries out, for example, a function of driving a liquid crystal display circuit, an imaging circuit including a CCD circuit, a D/A converting circuit, and/or a memory circuit such as an EEPROM.

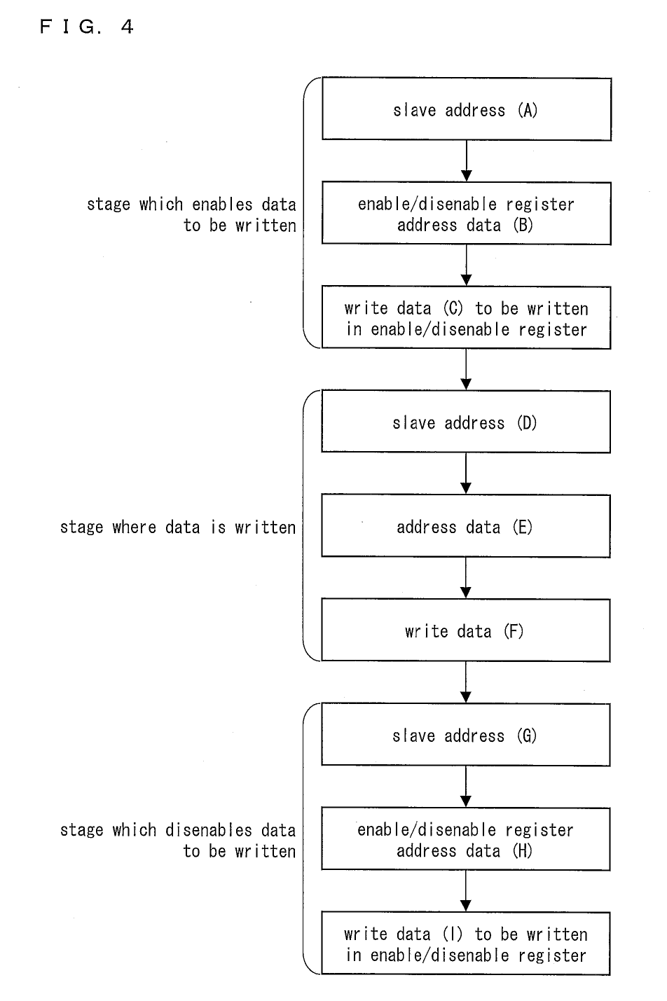

The following description will discuss, with reference to FIGS. 4 and 5, a write sequence and a transmission protocol which are employed by the electronic device 1.

FIG. 4 is a view illustrating a write sequence employed by a serial data communication method of the electronic device 1.

The electronic device 1 is configured to identify a slave device 3 of the N slave devices 3 which establishes serial data communication with the master device 2 based on slave address (A) (first data) which is sent, via the serial data communication, from the master device 2 to the N slave devices 3. The slave address (A) specifies the slave device 3 (specifies a device with which the master device 2 establishes the serial data communication) out of the N slave devices 3.

As illustrated in FIG. 4, a stage, which enables data to be written in the register other than the enable/disenable register 11 of the register group 10 in the write sequence employed by the electronic device 1, is made up of (i) the slave address (A), (ii) enable/disenable register address data (B) (second data) which specifies where the enable/disenable register 11 is in the register group 10, and (iii) write data (C) (third data), to be written in the enable/disenable register 11, which will serve as each unique and specific data (enable write data) for a corresponding slave device 3.

A stage where data is written in the register other than the enable/disenable register 11 of the register group 10 in the write sequence employed by the electronic device 1, is made up of (i) slave address (D) (first data) identical to the slave address (A), (ii) address data (E) (fifth data) which specifies where the register other than the enable/disenable register 11 is in the register group 10, and (iii) write data (F) (sixth data) to be written in the register other than the enable/disenable register 11 of the register group 10.

A stage, which disenables data to be written in the register other than the enable/disenable register 11 of the register group 10 in the write sequence employed by the electronic device 1, is made up of (i) slave address (G) (first data) identical to each of the slave address (A) and the slave address (D), (ii) enable/disenable register address data (H) (second data) which specifies where the enable/disenable register 11 is in the register group 10 and is identical to the enable/disenable register address data (B), and (iii) write data (I) (fourth data) which is to be written in the enable disenable register 11 and will serve as data (disenable write data) other than the specific data (enable write data).

Note that, in the present embodiment, different addresses are assigned to the enable/disenable registers 11 of the respective N slave devices 3.

That is, according to the N slave devices 3, each unique address is assigned to a corresponding enable/disenable register 11.

With the configuration, (i) slave address, (ii) address of an enable/disenable register 11, and (iii) write data which is to be written in the enable/disenable register 11 and will serve as specific data (enable write data), are each unique to a corresponding one of the N slave devices 3.

This causes a further reduction in possibility that data can be erroneously written in an unintended slave device 3, even in a case where (i) an erroneous value is sampled as a slave address due to noise and (ii) the unintended slave device is identified. This is because (i) address of an enable/disenable register 11 of an intended slave device 3 is different from that of an enable/disenable register 11 of the unintended slave device 3 and (ii) specific data of the intended slave device 3 is different from that of the unintended slave device 2. It is therefore possible to realize the electronic device 1 capable of preventing malfunction, as much as possible, caused by writing of an erroneous value.

FIG. 5 is a view illustrating a transmission protocol example employed by the electronic device 1.

(a) of FIG. 5 corresponds to the stage which enables data to be written in a register other than the enable/disenable register 11 of the register group 10 illustrated in FIG. 4.

In a case where the master device 2 establishes communication with a slave device 3, the master device 2 should first obtain a right to use the I2C bus transmission path 4.

In order to obtain such a right, the master device 2 issues and transmits a start condition, as illustrated in (a) of FIG. 5. This can be achieved by causing a voltage level of the data signal line SDA to be switched from High to Low while maintaining high the clock signal line SCL.

In a case where data is written in the slave device 3 from the master device 2, the master device 2 first transmits, to the slave device 3, (i) the start condition, (ii) 7-bit slave address (A) which identifies one of the N slave devices 3, and (iii) a 1-bit write signal (Low signal) (see (a) of FIG. 5).

An I2C reception section 18 of the slave device 3 receives the data from the master device 2, via a bidirectional buffer 13 and a noise removing and synchronizing section 15 of the slave device 3 (see FIG. 1).

In a case where the slave device 3 is ready to receive, it (i) receives 8-bit enable/disenable register address data (B) and 8-bit write data (C) while notifying the master device 2 of “ACK” at a timing illustrated in (a) of FIG. 5 and (ii) writes the 8-bit write data (C) at corresponding address of an enable/disenable register 11 of a register group 10. Each 8-bit enable/disenable register address data (B) is unique to a corresponding slave device 3, and specifies where the enable/disenable register 11 is in the register group 10. The 8-bit write data (C) is to be written in the enable/disenable register 11, and will serve as specific data unique to the slave device 3.

In a case where the slave device 3 could not receive the data, it transmits “NACK” to the master device 2 so as to notify the master device 2 of a defect of data transfer.

Specifically, the slave device 3 can notify the master device 2 of the “NACK” by causing the bidirectional buffer 13 to have high impedance at the ninth bit of a clock signal.

According to the present embodiment, in a case where one of the N slave devices 3 transmits “NACK” indicating that the one of the N slave devices 3 could not receive the slave address (A) and (D), it is not possible to write data in a register other than an enable/disenable register 11 of a register group 10 in the one of the N slave devices 3.

According to the present embodiment, in a case where the master device 2 receives, from one of the N slave devices 3 which is specified by slave address (A), (D) and (G), “NACK” indicating that the one of the N slave devices 3 could not receive the slave address (A), (D) and (G), the master device 2 retransmits the slave address (A), (D) and (G) to the one of the N slave devices 3.

With the configuration, in one of the N slave devices 3 which has recognized the slave address (A) and (D), data can be written in a register other than an enable/disenable register 11 of a register group 10, In contrast, in one of the N slave devices 3 which cannot recognize the slave address (A) and (D), data cannot be written in a register other than an enable/disenable register 11 of a register group 10.

More specifically, for example, in a case where the master device 2 establishes serial data communication with a specific one of the N slave devices 3, data cannot be written in a register other than an enable/disenable register of a register group 10 in each slave device 3 other than the specific one of the N slave devices 3.

It is therefore possible to realize an electronic device 1 capable of preventing malfunction caused by writing of an erroneous value.

With the configuration, even in a case of enabling data to be written in a register other than an enable/disenable register 11 of a register group 10 included in a slave device 3, it is possible to disenable the data to be written in the register other than the enable/disenable register 11 of the register group included in the slave device 3 which cannot recognize the slave address (A) and (D). It is therefore possible to prevent a state, where data can be written, from being kept. This makes it possible to realize an electronic device 1 capable of preventing malfunction caused by writing of an erroneous value.

According to the slave device 3, (i) “ACK” or “NACK” is issued on the basis of a determination, made by the I2C control section 17, as to whether or not the I2C reception section 18 has properly received data and (ii) the “ACK” or “NACK” is transmitted to the I2C section 6 of the master device 2, via the noise removing and synchronizing section 15 and the bidirectional buffer 13 (see FIG. 1).

(b) of FIG. 5 corresponds to the stage where data is written in the register other than the enable/disenable register 11 of the register group 10 illustrated in FIG. 4.

(c) of FIG. 5 corresponds to the stage which disenables data to be written in the register other than the enable/disenable register 11 of the register group 10 illustrated in FIG. 4.

Note that (i) a transmission method carried out in a case where the master device 2 writes, in a slave device 3, slave address (D), address data (E), and write data (F) which are illustrated in (b) of FIG. 5 and (ii) a transmission method carried out in a case where the master device 2 writes, in a slave device 3, slave address (G), address data (H), and write data (I) which are illustrated in (c) of FIG. 5, are identical to that illustrated in (a) of FIG. 5. Therefore, descriptions of the transmission methods are omitted.

After such data transfer completes, the slave device 3 suspends transmitting of “ACK” or “NACK” to the master device 2. The master device 2 recognizes completion of the data transfer by recognizing that the slave device 3 has suspended transmitting of “ACK” or “NACK.”

Then, the master device 2 issues a stop condition so as to open the I2C bus transmission path 4. This can be achieved by causing a voltage level of the data signal line SDA to be switched from Low to High while maintaining high the clock signal line SCL.

Specifically, the CPU 5 issues and transmits the stop condition.

According to the present embodiment, in a case where the slave device 3 detects a start condition, the register writing section 9 is made enable so that the register writing section 9 can write data in the enable/disenable register 11 of the register group 10. In contrast, in a case where the slave device 3 detects a stop condition, the register writing section 9 is made disenable so that the register writing section 9 cannot write data in the enable/disenable register 11 of the register group 10.

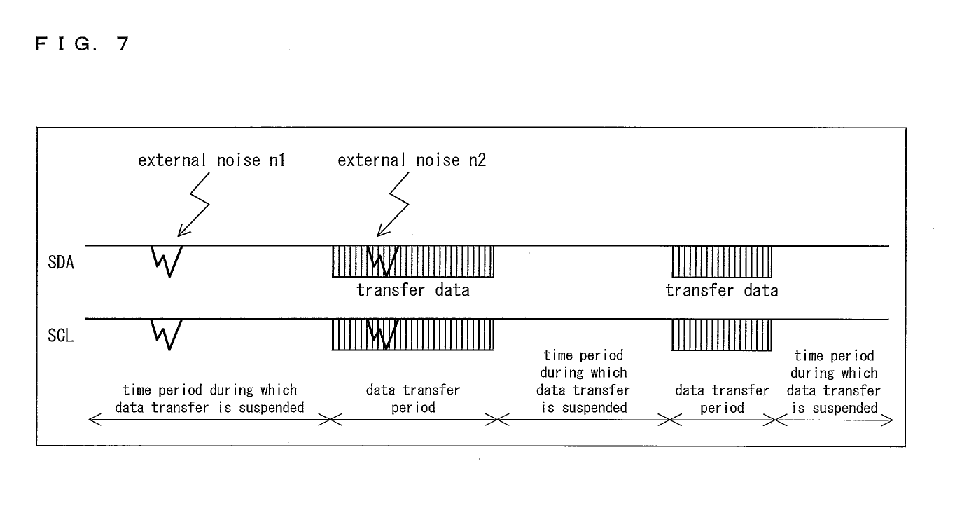

With the configuration, the register writing section 9 cannot write data in the enable/disenable register 11 during a time period from issuance of a stop condition to issuance of a start condition (for example, during the time period during which data transfer is suspended (see in FIG. 7)). It is therefore possible to realize an electronic device 1 capable of preventing malfunction caused by external noise n1 illustrated in FIG. 7.

According to the present embodiment, the number of types of specific 8-bit data, each being unique to a corresponding slave device 3 and each enabling data to be written in a register other than an enable/disenable register 11 of a register group 10, is set to be smaller than that of types of data other than the specific 8-bit data, each disenabling data to be written in the register other than the enable/disenable register 11 of the register group 10.

This causes reduction in possibility that data can be written in the register other than the enable/disenable register 11 of the register group 10, even in a case where (i) an erroneous value is sampled due to noise in serial data communication and (ii) the erroneous value is written to the enable/disenable register 11 of the register group 10. It is therefore possible to realize an electronic device 1 capable of preventing malfunction, as much as possible, caused by writing of an erroneous value.

The number of types of the specific 8-bit data can be 1 (one).

It is preferable that the specific 8-bit data is a binary data, i.e., high level or low level and is switched, at least twice, from high level to low level or from low level to high level.

Furthermore, it is preferable that the specific 8-bit data is switched between high level and low level on a clock cycle of a clock signal.

By setting the specific 8-bit data as described above, it is possible to further reduce a possibility that the specific 8-bit data becomes identical to an erroneous value even in a case where the erroneous value is sampled due to noise in serial data communication.

It is preferable to configure the electronic device of the present invention such that the control section disenables data to be written in the at least part of the storage section other than the first part, in a case where second specific data different from the first specific data is written in the first part via the serial data communication.

According to the configuration, for example, data is written in the at least part of the storage section other than the first part of the storage section included in the second device. Then, the control section disenables data to be written in the at least part of the storage section other than the first part, in a case where the second specific data different from the first specific data is written in the first part via the serial data communication.

Therefore, data cannot be written in the at least part of the storage section other than the first part of the storage section during a time period other than a time period during which data is written in the at least part of the storage section other than the first part of the storage section, for example, during a time period during which data transfer is suspended in the serial data communication.

According to the configuration, it is therefore possible to realize an electronic device capable of preventing possible erroneous writing during the time period other than the time period during which data is written in the at least part of the storage section other than the first part of the storage section included in the second device.

It is preferable to configure the electronic device of the present invention such that the number of types of the first specific data is smaller than that of types of the second specific data.

According to the configuration, the number of types of the first specific data is set smaller than that of types of the second specific data.

That is, according to the configuration, a first possibility that the control section enables data to be written in the at least part of the storage section other than the first part of the storage section is set lower than a second possibility that the control section disenables data to be written in the at least part of the storage section other than the first part of the storage section.

It is therefore possible to realize an electronic device capable of preventing malfunction, as much as possible, caused by writing of erroneous data even in a case where (i) the erroneous data is sampled due to noise in serial data communication and (ii) the erroneous data is written in the first part. This is because the first possibility is set lower than the second possibility.

It is preferable to configure the electronic device of the present invention such that the number of types of the first specific data is 1 (one).

According to the configuration, the number of types of the first specific data is 1 (one). It is therefore possible to realize an electronic device capable of preventing malfunction, as much as possible, caused by writing of erroneous data even in a case where (i) the erroneous data is sampled due to noise in serial data communication and (ii) the erroneous data is written in the first part. This is because the first possibility is further lowered.

It is preferable to configure the electronic device of the present invention such that the first specific data is binary data of high level or low level, and is switched, at least twice, from high level to low level or from low level to high level.

It is preferable to configure the electronic device of the present invention such that the first specific data is switched between high level and low level on a clock cycle of a clock signal transmitted to the second device from the first device via the clock signal line.

According to the configuration, the first specific data is data which minutely changes between high level and low level.

It is therefore possible to further reduce the possibility that the first specific data becomes identical to erroneous data even in a case where the erroneous data is sampled due to noise in serial data communication.

It is preferable to configure the electronic device of the present invention such that the control section enables the data to be written in the first part, upon receipt of a command to start the serial data communication from the first device, and the control section disenables the data to be written in the first part, upon receipt of a command to stop the serial data communication from the first device.

According to the configuration, the control section enables the data to be written in the first part when the second device detects the command (start condition) to start the serial data communication, and the control section disenables the data to be written in the first part when the second device detects the command (stop condition) to stop the serial data communication.

It is therefore impossible to write data in the first part during a time period from issuance of a command to stop the serial data communication to issuance of a command to start the serial data communication, that is, during a time period during which data transfer is suspended. This makes it possible to realize an electronic device capable of preventing malfunction caused by external noise.

It is preferable to configure the electronic device of the present invention such that the second device is made up of a plurality of second devices, and one of the plurality of second devices, with which the first device establishes the serial data communication, is specified in accordance with a second device specifying signal which (i) is transmitted, via the serial data communication, from the first device to the plurality of second devices and (ii) specifies the one of the plurality of second devices.

According to the configuration, the second device specifying signal for specifying the one of the plurality of second devices, with which the first device establishes the serial data communication, is transmitted, via the serial data communication, from the first device to the plurality of second devices. It is therefore possible to realize an electronic device, with no increase in the number of signal lines, which is capable of preventing malfunction caused by writing of erroneous data.

Further, according to the configuration, even in a case where a second device, with which the first device does not establish the serial data communication, erroneously receives the second device specifying signal due to noise, data cannot be written in at least a part of a storage section other than a first part of the storage section of the second device, with which the first device does not establish the serial data communication, unless the first specific data is written to the first part of the storage section of the second device, with which the first device does not establish the serial data communication. It is therefore possible to realize an electronic device capable of preventing malfunction caused by writing of erroneous data.

It is preferable to configure the electronic device of the present invention such that the second device is made up of a plurality of second devices, and the control section disenables the data to be written in the at least part of the storage section other than the first part of the storage section, in a second device whose second device specifying signal is not recognizable, the second device specifying signal (i) being transmitted, via the serial data communication, from the first device to the plurality of second devices and (ii) specifying the one of the plurality of second devices.

According to the configuration, in a second device whose second device specifying signal is recognizable, data can be written in at least part of a storage section other than a first part of the storage section included in the second device whose second device specifying signal is recognizable. In contrast, in a second device whose second device specifying signal is not recognizable, data cannot be written in at least part of a storage section other than a first part of the storage section included in the second device whose second device specifying signal is not recognizable.

Therefore, for example, in a case where the first device is in the serial data communication with a specific second device of the plurality of second devices, data cannot be written in at least part of a storage section other than a first part of the storage section included in a second device other than the specific second device of the plurality of second devices.

It is therefore possible to realize an electronic device capable of preventing malfunction caused by writing of erroneous data.

Further, according to the configuration, even in a case where a control section enables data to be written in at least part of a storage section other than a first part of the storage section included in a second device which cannot recognize the second device specifying signal, it is possible to disenable the data to be written in the at least part in the second device. It is therefore possible to prevent a state, where data can be written, from being kept. This makes it possible to realize an electronic device capable of preventing malfunction caused by writing of erroneous data.

It is preferable to configure the electronic device of the present invention such that the plurality of second devices share the data signal line and the clock signal line.

According to the configuration, the plurality of second devices share the data signal line and the clock signal line. It follows that the first device has merely two output terminals for respective of the data signal line and the clock signal line. It is therefore possible to decrease the number of output terminals of the first device.

Further, in a case of the configuration, an output section for outputting a data signal and a clock signal is realized by, for example, an open collector device or an open drain device whose output impedance is relatively high. This causes the output section to be susceptible to noise. In view of the circumstances, it is possible to suitably employ the configuration of the present invention, which can prevent malfunction caused by writing of erroneous value data.

It is preferable to configure the electronic device of the present invention such that each first specific data is unique to a corresponding one of the plurality of second devices.

According to the configuration, the first specific data is different from one second device to another second device of the plurality of second devices.

Therefore, (i) the each first specific data and (ii) each second device specifying signal which identifies one of the plurality of second devices are unique to a corresponding one of the plurality of second devices.

This causes a further reduction in possibility that data can be erroneously written in at least part of a storage section other than a first part of the storage section included in an unintended second device, even in a case where (i) erroneous data is sampled as a second device specifying signal due to noise and (ii) the unintended second device is identified. This is because specific data of the intended second device is different from that of the unintended second device. It is therefore possible to realize an electronic device capable of preventing malfunction, as much as possible, caused by writing of erroneous data.

It is preferable to configure the electronic device of the present invention such that each first part is unique to a corresponding one of the plurality of second devices.

According to the configuration, the first part of the storage section is different from one second device to another second device of the plurality of second devices.

Therefore, (i) the each first part and (ii) the each second device specifying signal which identifies one of the plurality of second devices are peculiar to a corresponding one of the plurality of second devices.

This causes a further reduction in possibility that data can be erroneously written in at least part of a storage section other than a first part of the storage section included in an unintended second device, even in a case where (i) erroneous data is sampled as a second device specifying signal due to noise and (ii) the unintended second device is identified. This is because the first part of the storage section included in the unintended second device is different from that of a storage section included in an intended second device. It is therefore possible to realize an electronic device capable of preventing malfunction, as much as possible, caused by writing of erroneous data.

The electronic device of the present invention can suitably apply I2C serial data communication.

It is preferable that in a serial data communication method of the present invention, data, to be communicated via the data signal line and the clock signal line, contains: (i) the enabling data in the serial data communication method; (ii) the first data; (iii) the second data; and (iv) fourth data which is different from the third data, each of the first data, the second data, and the fourth data disenabling data to be written in the at least part other than the first part of the storage section.

It is preferable that in the serial data communication method of the present invention, after the enabling data is transmitted, writing data is transmitted, which writing data contains (i) the first data, (ii) fifth data which specifies the part other than the first part in the storage section, and (iii) sixth data to be written in the part other than the first part of the storage section, and after the writing data is transmitted, the first data, the second data, and the fourth data are transmitted.

According to the method, it is possible to disenable data to be written in the at least part other than the first part of the storage section after writing data in the at least part other than the first part of the storage section.

It is therefore possible to disenable data to be written in the at least part other than the first part of the storage section during a time period other than a time period during which data is written in the at least part other than the first part of the storage section such as (i) a time period during which data transfer is suspended in the serial data communication or (ii) a time period of the serial data communication established between the master device 2 and a specific slave device 3, during which time period a slave device 3 other than the specific slave device 3 does not establish the serial data communication with the master device 2.

Therefore, according to the method, it is possible to prevent possible erroneous writing during the time period other than the time period during which data is written in the at least part other than the first part of the storage section.

The present invention is not limited to the description of the embodiments above, and can therefore be modified by a skilled person in the art within the scope of the claims. Namely, an embodiment derived from a proper combination of technical means disclosed in different embodiments is encompassed in the technical scope of the present invention.

### INDUSTRIAL APPLICABILITY

The present invention is applicable to an electronic device including a master device and a slave device which establish serial data communication with each other.

### REFERENCE SIGNS LIST

1: electronic device
2: master device (first device)
3: slave device (second device)
4: I2C bus transmission path
9: register writing section (control section)
10: register group (storage section)
11: enable/disenable register (first part of the storage section)
12: function block (control section)
SDA: data signal line
SCL: clock signal line

1. An electronic device including:
a first device; and
a second device including a storage section and a control section,
the first device and the second device establishing serial data communication with each other via a data signal line and a clock signal line,
the control section enabling data to be written in at least part of the storage section other than a first part of the storage section, in a case where first specific data is written in the first part via the serial data communication.

2. The electronic device as set forth in claim 1, wherein:
the control section disenables data to be written in the at least part of the storage section other than the first part, in a case where second specific data different from the first specific data is written in the first part via the serial data communication.

3. The electronic device as set forth in claim 2, wherein:
the number of types of the first specific data is smaller than that of types of the second specific data.

4. The electronic device as set forth in claim 1, wherein:
the number of types of the first specific data is 1 (one).

5. The electronic device as set forth in claim 1, wherein:
the first specific data is binary data of high level or low level, and is switched, at least twice, from high level to low level or from low level to high level.

6. The electronic device as set forth in claim 5, wherein:
the first specific data is switched between high level and low level on a clock cycle of a clock signal transmitted to the second device from the first device via the clock signal line.

7. The electronic device as set forth in claim 1, wherein:
the control section enables the data to be written in the first part, upon receipt of a command to start the serial data communication from the first device, and
the control section disenables the data to be written in the first part, upon receipt of a command to stop the serial data communication from the first device.

8. The electronic device as set forth in claim 1, wherein:
the second device is made up of a plurality of second devices, and
one of the plurality of second devices, with which the first device establishes the serial data communication, is specified in accordance with a second device specifying signal which (i) is transmitted, via the serial data communication, from the first device to the plurality of second devices and (ii) specifies the one of the plurality of second devices.

9. The electronic device as set forth in claim 1, wherein:
the second device is made up of a plurality of second devices, and
the control section disenables the data to be written in the at least part of the storage section other than the first part of the storage section, in a second device whose second device specifying signal is not recognizable,
the second device specifying signal (i) being transmitted, via the serial data communication, from the first device to the plurality of second devices and (ii) specifying the one of the plurality of second devices.

10. The electronic device as set forth in claim 8, wherein:
the plurality of second devices share the data signal line and the clock signal line.

11. The electronic device as set forth in claim 8, wherein:
each first specific data is unique to a corresponding one of the plurality of second devices.

12. The electronic device as set forth in claim 8, wherein:
each first part is unique to a corresponding one of the plurality of second devices.

13. The electronic device as set forth in claim 1, wherein:
the serial data communication is I2C communication.

14. A serial data communication method carried out by use of a data signal line and a clock signal line, wherein:
enabling data, which enables data to be written in at least part of a storage section other than a first part of the storage section included in a target device with which the serial data communication is established via the data signal line and the clock signal line, contains:
first data which specifies the target device;
second data which specifies the first part in the storage section included in a specified target device, and
third data to be written in the first part of the storage section.

15. A serial data communication method, wherein:
data, to be communicated via the data signal line and the clock signal line, contains:
(i) the enabling data in the serial data communication method recited in claim 14;
(ii) the first data;
(iii) the second data; and
(iv) fourth data which is different from the third data,
each of the first data, the second data, and the fourth data disenabling data to be written in the at least part other than the first part of the storage section.

16. The method as set forth in claim 15, wherein:
after the enabling data is transmitted, writing data is transmitted, which writing data contains (i) the first data, (ii) fifth data which specifies the part other than the first part in the storage section, and (iii) sixth data to be written in the part other than the first part of the storage section; and
after the writing data is transmitted, the first data, the second data, and the fourth data are transmitted.
